(19) United States
(12) Patent Application Publication
(10) Pub. No.: US 2022/0164751 A1
(43) Pub. Date: May 26, 2022

(54) AUTOMATIC PERSONA GENERATION

(71) Applicant: International Business Machines Corporation, Armonk, NY (US)

(72) Inventors: Rahul Nair, Dublin (IE); Oznur Alkan, Clonsilla (IE); Bei Chen, Blanchardstown (IE); Elizabeth Daly, Dublin (IE)

(21) Appl. No.: 17/104,184

(22) Filed: Nov. 25, 2020

(51) Int. Cl. G06Q 10/06; G06Q 30/02

(52) U.S. Cl. CPC G06Q 10/06398; G06Q 30/0201

(57) ABSTRACT

Technology for computer systems for helping candidates (that is, candidate entities, like people or enterprises) for performing a task to know what portions of the entity's profile could use revision or improvement in order to increase the probability that the candidate entity will, in due course, be selected to perform the task. In some embodiments: (i) the task is the provision of cloud computing services; and (ii) the candidates are various companies in the business of providing cloud computing services.

### BACKGROUND

The present invention relates generally to the field of machine logic (for example, software) used to match entities to tasks and more particularly to machine logic for matching entities providing cloud computing services to enterprises that need large amounts of cloud computing services.

One concept known in the field of computing is the use of “profiles” to characterize entities (for example, individual people, small enterprises, large enterprises) using a set of parameter values. For example, ABC Company has: (i) a name of “ABC Co.”; (ii) 50 employees; (iii) an annual payroll of $5,000,000 (USD); (iv) 10 acres of real estate; (v) $1,234,567.89 in its various bank accounts; and (vi) a credit score of 564. In this example, these six (6) parameter values could be used to form a profile as follows: “ABC Co.”, 50, 50000000, 10, 1234567.89, 564. In order to use this profile, a piece of software would need to be able to access the meaning of each of the values in the profile, and also the ordering convention used to order the various values within the profile.

It is known that some machine logic will make choices between entities based on the profiles of the entities. For example, an auction house might have software that decides who may participate in an auction based on profiles. This is one example, of “choosing between entities to be used to perform a task,” specifically, in this example, choosing which entities will perform the task of sitting in on, and perhaps bidding at, an upcoming auction. There are many, many other examples of software that uses entity profiles to choose among and between competing entities. Sometimes the choice takes the form of deciding which entities are to be recommended to human deciders for performing a task—where the human individual(s) make the ultimate decision about who will perform the task. In other known art, the software actually makes the ultimate decision about what entity(ies) will perform a given task based on profiles of candidates for performing the task.

### SUMMARY

According to an aspect of the present invention, there is a method, computer program product and/or system that performs the following operations (not necessarily in the following order): (i) receives a target profile with respect to a first task, with the target profile including a plurality of parameter values and/or ranges that: (a) are associated with entities that have historically been successful at performing the first task, and (b) respectively correspond to a plurality of profile parameters; (ii) receives a first candidate entity profile including a plurality of parameter values characterizing a candidate entity, with the plurality of parameters of the first candidate entity profiles respectively corresponding to the plurality of profile parameters; (iii) determines a first gap between the following: (a) a first parameter value and/or range of the plurality of parameter values and/or ranges of the target profile, and (b) a first parameter value and/or range of the plurality of parameter value of the target profile; and (iv) performs gap analysis to identity a first action that may be undertaken by the first candidate entity to decrease or eliminate the first gap.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a block diagram showing a machine logic (for example, software) portion of a second embodiment system.

### DETAILED DESCRIPTION

Some embodiments of the present invention are directed to computer systems for helping candidates (that is, candidate entities, like people or enterprises) for performing a task to know what portions of the entity's profile could use revision or improvement in order to increase the probability that the candidate entity will, in due course, be selected to perform the task. In some embodiments: (i) the task is the provision of cloud computing services; and (ii) the candidates are various companies in the business of providing cloud computing services. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

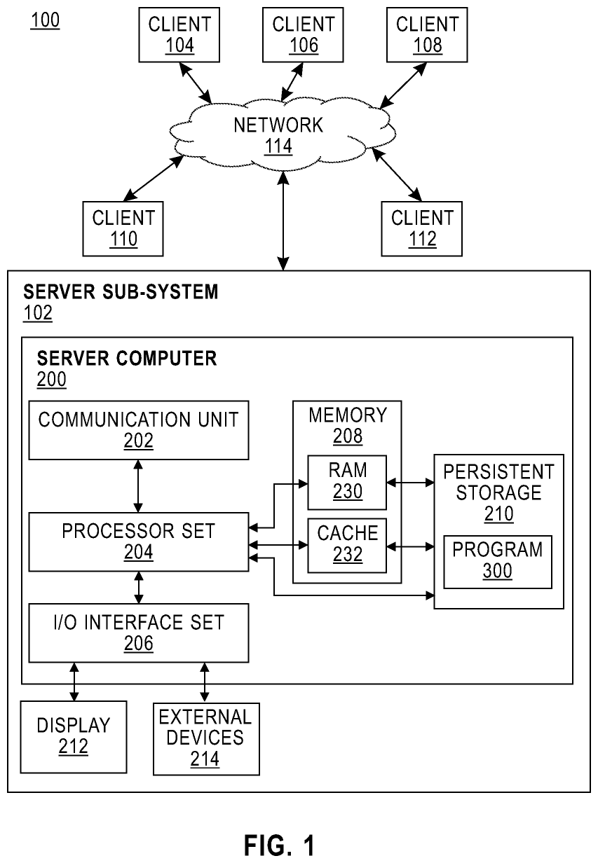

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

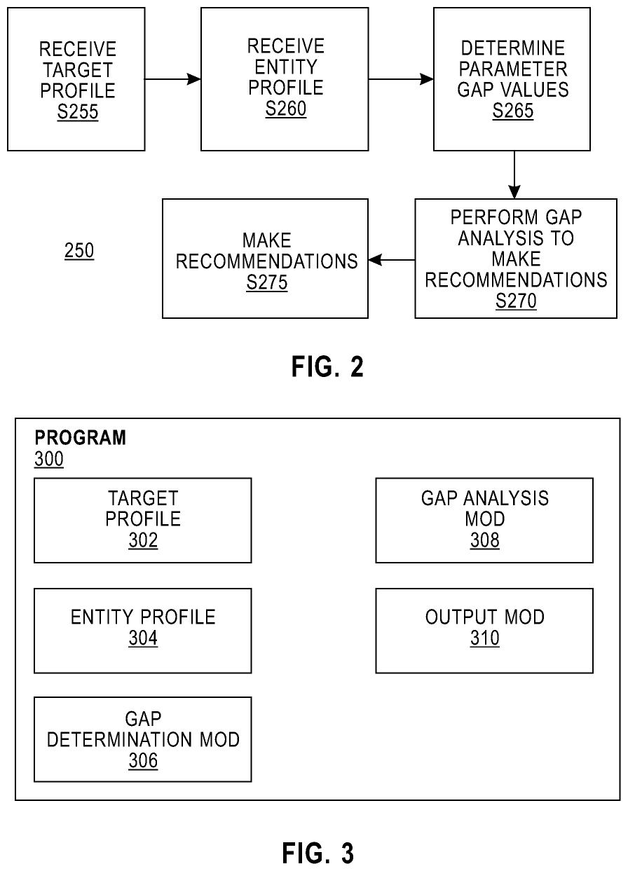

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where target profile 302 is received from client sub-system 104 through communication network 114. The target profile is a set of parameter values for a predetermined set of parameters that have historically characterized entities that have successfully performed a given task. In this example, the task is the provision of cloud computing services for a large-scale manufacturing concern with worldwide operations. The following sub-section of this Detailed Description section may include further information regarding how target profiles may be calculated. The type of target profiles used in the following sub-section of this Detailed description section are called “personas,” which term is defined in the following sub-section of this Detailed Description section. In the simple teaching example of FIGS. 1 to 4. Target profile 302 includes four (4) parameter values as follows: (i) profile identity=“TARGET”; (ii) number of data centers=4 or more; (iii) number of virtual machines that can be instantiated from virtual machine image(s) upon four hours' notice=1,000,000,000 or more; and (iv) number of containers that that can be instantiated from container image(s) upon four hours' notice=1,500,000,000 or more.

Processing proceeds to operation S260, where entity profile 304 (sometimes referred to as a “candidate entity profile”) is received from client sub-system 106 (that is, the computer system of a cloud computing services provider called XYX Co.). According to XYX's candidate profile: (i) profile identity=“XYZ Co.”; (ii) number of data centers=6; (iii) number of virtual machines that can be instantiated from virtual machine image(s) upon four hours' notice=2,000,000,000; and (iv) number of containers that that can be instantiated from container image(s) upon four hours' notice=1,000,000,000. These parameter values characterize XYZ's capabilities in respects relevant to the task of providing cloud computing services.

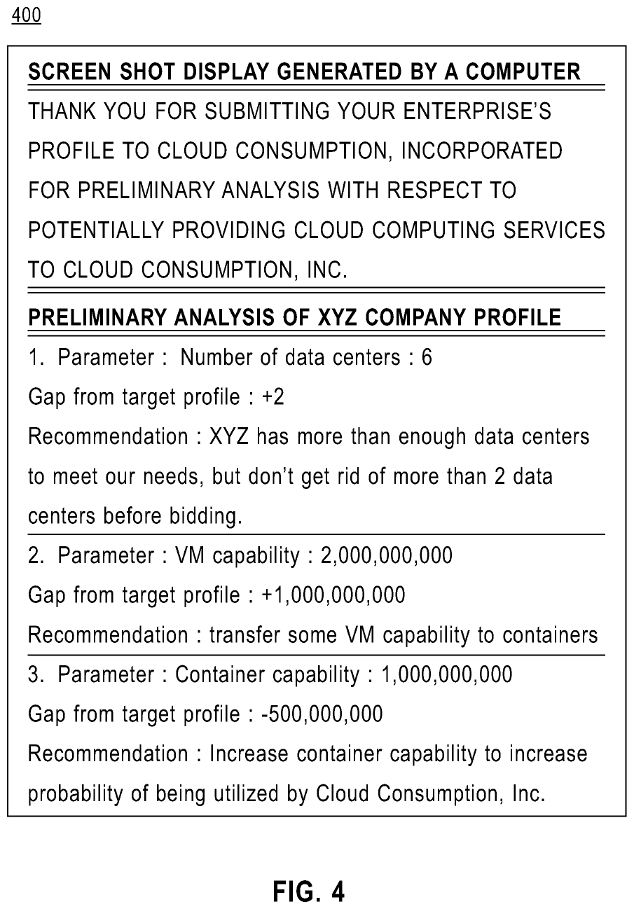

Processing proceeds to operation S265, where gap determination mod 306 determines a gap between target profile 302 and the candidate entity profile 304. These gaps are the differences (other than identity) between the target profile and the candidate entity profile, which in this example calculates out as follows: (i) number of data centers parameter gap=+2; (ii) VM (virtual machine) capability gap=+1,000,000,000; and (iii) container capability gap=−500,000,000. These gaps are shown in screen shot 400 of FIG. 4.

Processing proceeds to operation S270 where gap analysis mod 308 performs gap analysis to determine how any negative gaps might be mitigated and/or reversed in polarity. In this example, and as shown in FIG. 4, the recommendation is to try to convert some of the excess VM instantiating capability into container instantiating capability. In this way XYZ can make itself more suitable to the task of providing cloud computing services to the manufacturing concern mentioned above. Gap analysis is discussed in greater detail in the next sub-section of this Detailed Description section.

Processing proceeds to step S275 where output mod 310 outputs the results of the gap analysis back to client sub-system 106, where it appears as screen shot 400 of FIG. 4 to the appropriate personnel at XYZ Co. who will decide whether to follow the recommendation and reconfigure their data centers to fill in the gap (that is, container capability) identified by the gap analysis of this embodiment of the present invention.

### III. Further Comments and/or Embodiments

A method according to an embodiment of the present invention includes the following operations (not necessarily in the following order): (i) receives the following inputs: training data, test instance, prediction model and/or explanation module; (ii) outputs one, or more, of the following: collection of successful personas, recommendation of actions to target successful persona, ranking of recommended target personas; and (iii) taking aforementioned inputs and aforementioned outputs and performing one, or more, of the following actions: (a) persona generation, which is generation of a collection of discriminant personas/profiles that an explainer module has deemed to be relevant to success, (b) gap analysis, which is a plurality of recommendations for a next best action for changes to the input test instance to reach each of the target success personas, and (c) ranking: a ranking of the target personas according to metrics such as achievability/importance/distance of test instance to collection of target success personas.

Some embodiments of the present invention recognize one, or more, of the following facts, potential problems and/or potential areas for improvement with respect to the current state of the art: (i) end-state is automatically generated and does not require user input; (ii) involves a concept of machine-driven predictions/recommendations and a notion of an archetypical user; (iii) gap analysis is performed; (iv) includes a reasoning algorithm for persona generation; (v) includes a gap analysis algorithm to map the competency vector to success criteria in the domain; (vi) performs gap analysis between the user and a target persona and generates recommendations to reach that target persona; and/or (vii) uncovering the determining factors that influence or the cause of success or expertise.

Some embodiments of the present invention, related to the field of personas, may include one, or more, of the following operations, features, characteristics and/or advantages: (i) a persona is a archetypical user created by synthesizing descriptions of user segments which include: (a) drive decision making processes through presenting common user profiles, and/or (b) allow market segmentation and targeting; (ii) generate, by user surveys, design thinking workshops, etc.; and/or (iii) pertains to the automatic, data-driven method to generate personas when outcomes are of interest including: (a) for example: “success” or “failure” outcomes related to sales opportunity, (b) the need to discriminative WRT (web runtime) to the outcome, (c) involves a system and method that leverage a machine learning model, a model explanation component and role generation methods to generate a persona, and/or (d) uses a gap analysis component to determine needed success criteria between a user profile and a target success profile.

Some embodiments of the present invention may include one, or more, of the following operations, features, characteristics and/or advantages with reference to motiving use cases: (i) stems from engagements with large company executives; (ii) involves channel selection where: (a) decisions made pertaining to how a large company should respond to a sales opportunity where: (1) each channel (internal sales team or external partner) has pros and cons, and/or (2) each channel has different win probabilities, and/or (b) knowing different success sales personas allows translating lost deals to wins by changing the channel or by adjusting deal attributes to move the opportunity to be “nearest” to a success persona; and/or (iii) considers business partner (BP) trajectory where a relatively new BP, wishing to understand where to focus in order to grow their business and progress, can be shown the different automatically generated persona of successful BPs.

Some embodiments of the present invention may include one, or more, of the following operations, features, characteristics and/or advantages: (i) a system and method for automatic persona generation that provides: (a) personas that are discriminant for specific outcomes, and/or (b) success criteria for specific user profiles with respect to (“WRT”) outcomes; (ii) employs: (a) a prediction model to estimate outcomes, (b) an explanation component to provide justification for outcome, (c) a reasoning component to build personas, and/or (d) a gap analysis component to map partial user profiles to a set of persona; (iii) leverages past data on outcomes to guide new outcomes; and/or (iv) does so in human-understandable ways using personas.

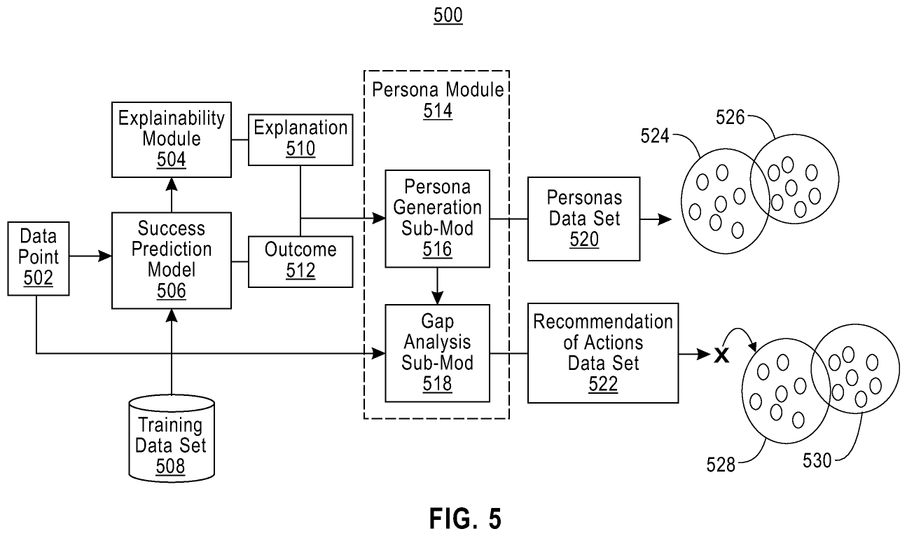

As shown in FIG. 5, diagram 500 includes: data point 502; explainability module (“mod”) 504; success prediction model 506; training data set 508; explanation 510; outcome 512; persona mod 514; persona generation sub-mod 516; gap analysis sub-mod 518; personas data set 520; recommendation of actions data set 522; Type A success person shape 524; Type B success person shape 526; Type A success person shape 528; and Type B success person shape 530.

Data point 502 is a data point that is input to a computer system that is, software (for example, blocks 504, 506 and 514) running hardware (not shown in FIG. 5.) In this example, the data point includes information indicative of all the attributes needed by the system to make a prediction.

Success prediction model 506 processes the data point to obtain: (i) output sent to explainability model 504 in the form of; (a) a predicted label (outcome), (b) the training machine learning model decision function, (c) input features, and/or (d) optionally include the training dataset; and/or (ii) outcome 512 which includes information indicative of different outcomes for predicting success/failure of the task.

Explainability 504 performs explainability processing to obtain an output in the form of an explanation data set which includes information indicative of: (i) an algorithmically generated statement that provides evidence for “why” a prediction was made; (ii) stating attributes in the input data point that were crucially discriminative between success/failure; and/or (iii) takes the form of: (a) logical conditions, (b) causal links between features (data points), and/or (c) outcomes.

Persona module 516 receives the following inputs: explanation 510; outcome 512; and data point 502. Persona generation sub-mod 516 automatically generates a persona and outputs it as persona data set 520. Gap analysis sub-mod 518 analyzes the gap between the attributes of the data point and a success persona that is closest to this data point. Sub-mod 518 outputs recommendations of actions data set 522. Typical actions that may be recommended may include the following: (i) actions influenced by the use case; (ii) actions human's need to do (for example: change the deal mix, have fewer deals, etc.); and/or (iii) recommendations that are geared towards addressing the gap between the current and nearest success persona.

Some embodiments of the present invention may include one, or more, of the following operations, features, characteristics and/or advantages and includes: (i) a prediction model (typically a machine learning model) which includes: (a) a model output, and/or (b) a classification result (for example, success” or “failure”); (ii) an explainer (typically a model-agnostic method such as LIME (local interpretable model-agnostic explanations)) including: (a) a set of clauses that answer the question “why” of model output, and/or (b) an output (for example, a “success” label since REVENUE>40M and SECTOR=“SOCIAL”); (iii) persona generation (typically a reasoning algorithm) including: (a) from a global set of clauses, determine a (compact) representation of clauses (that is, roles) that lead to positive outcomes, and/or (b) an output (for example, Persona 1: “REVENUE>100M & SECTOR=“HARDWARE”, Persona 2: “REVENUE<10M & SECTOR=“SERVICES”) that are success profiles; and/or (iv) interactive gap analysis (typically an algorithm to measure similarity) including: (a) given a data point with a partial feature attribute set, determine a most likely role that maps to a data point for positive outcomes, and/or (b) an input data point: (for example, “REVENUE>100M”, output: “Persona 2” with “SECTOR=‘HARDWARE’”).

Some embodiments of the present invention may include one, or more, of the following operations, features, characteristics and/or advantages: (i) outcomes that need to be predicted are taken into account during persona generation; (ii) personas are discriminant between outcomes of interest; (iii) created personas represent a grouping of the data instances; and/or (iv) no differentiation between classes are taken into account during persona generation (that is, the generated personas reflect any features owned by target classes).

Some embodiments of the present invention recognize one, or more, of the following facts, potential problems and/or potential areas for improvement with respect to the current state of the art: (i) clustering methods offer no discriminant information on outcomes, since this is not known and needs to be predicted (typically using a machine learning model); (ii) clustering works independently from prediction tasks and are not related to the decision boundary of the outcome prediction task; (iii) using a sales example, clustering will tell you what cluster/type of opportunity it is, but not how it relates to win/loss probability (for which you need a prediction model); and/or (iv) clusters therefore do not indicate any success factors.

Some embodiments of the present invention may include one, or more, of the following operations, features, characteristics and/or advantages pertaining to business partner (BP) trajectory: (i) when a BP joins the organization, he/she often wants to know what it takes to succeed in the partnership (for example, category of products, certification, and acceleration (the average time to close a deal)); (ii) when an existing BP is failing, it is important to diagnose the causes promptly to help the BP improve; and/or (iii) a BP persona can help in both cases (as stated in items (i) and (ii) above) because the persona serves as: (a) a guideline for future success, and/or (b) a benchmark for diagnosis.

Some embodiments of the present invention may also include one, or more, of the following operations, features, characteristics and/or advantages also pertaining to business partner (BP) trajectory: (i) data driven role model generation has the advantage of creating feasible successful goals which can be the basis for recommendations; (ii) a relatively new BP wishing to understand where to focus in order to grow their business and progress, can be shown the different automatically generated role model of successful BPs; (iii) gap analysis can show what the BP would need to do to work towards these personas (for example, focus on fewer deals a month, upskill in the following products, and focus on large clients); and/or (iv) based on the current profile the system, can present which persona is most achievable for the user.

Some embodiments of the present invention may include one, or more, of the following operations, features, characteristics and/or advantages: (i) potential use across several commercial sectors, for example: (a) a business partner trajectory model that recommends a set of steps for partner growth; and/or (b) commercially available career advice/coaching software; and/or (ii) outputs of other systems are likely to advertise the outputs (for example, success prediction and persona guidance) making competing systems discoverable.

An embodiment of a gap analysis algorithm used by some embodiments of the present invention will now be discussed. In this embodiment of a gap analysis algorithm: (i) inputs are a set of personas P—from the generation module, that is, a test instance for which the “gap analysis” is performed; (ii) output is a ranked list of recommendations; (iii) the first operation processes a set of input personas P to determine the main descriptors (for example, if P describes clusters, the descriptor could be the centroid); (iv) the second operation computes the input test instance, that is, a similarity score s_p for each of the personas P (for example, this could be a distance metric; (v) the third operation ranks, in ascending order of s_p, all the success personas in P; (vi) the fourth operation determines minimal change in features of the input test instance to top ranked personas identified in the previous operation; and/or (vii) the fifth operation recommends all feasible changes identified in the previous operation as output recommendations or “gaps.”

As used in this document, the word “personas” refers to an archetypal profile of a segment of the population, that is, a segment that has similar traits and a summary description of that segment. For example, from a population of sellers, a “hardware specialist” persona is, in one example, a segment who do few large deals in specific sectors like Financials/Telco.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

1. A computer-implemented method (CIM) comprising:
receiving a target profile with respect to a first task, with the target profile including a plurality of parameter values and/or ranges that: (i) are associated with entities that have historically been successful at performing the first task, and (ii) respectively correspond to a plurality of profile parameters;
receiving a first candidate entity profile including a plurality of parameter values characterizing a candidate entity, with the plurality of parameters of the first candidate entity profiles respectively corresponding to the plurality of profile parameters;
determining a first gap between the following: (i) a first parameter value and/or range of the plurality of parameter values and/or ranges of the target profile, and (ii) a first parameter value and/or range of the plurality of parameter value of the first candidate entity profile; and
performing gap analysis to identify a first action that may be undertaken by the first candidate entity to decrease or eliminate the first gap;
wherein the performance of gap analysis uses the following inputs: a set of personas P from a generation module and a test instance for the gap analysis, with each persona P respectively corresponding to an archetypical user created by synthesizing descriptions of user segments;
wherein the user segments include a first user segment corresponding to individuals who perform large deals in the commercial area of financials;
wherein the performance of gap analysis generates the following output: a ranked list of recommendations; and
wherein the operation of performance of the gap analysis includes at least the following sub-operations:
processing a set of input personas P to determine main descriptors,
computing for the input test instance, a similarity score s_p for each of the personas P,
ranking, in ascending order of s_p, all the success personas in P, and
determining minimal change in features of input test instance to top ranked personas identified in the previous operation.

2. The CIM of claim 1 further comprising:
communicating the first action to the first candidate entity by an electronic communication made over a communication network.

3. The CIM of claim 1 wherein the first task is the provision of computing services.

4. The CIM of claim 3 wherein the first task is the provision of cloud computing services.

5-18. (canceled)

19. A computer-implemented method (CIM) comprising:
receiving a target profile with respect to a first task, with the target profile including a plurality of parameter values and/or ranges that: (i) are associated with entities that have historically been successful at performing the first task, and (ii) respectively correspond to a plurality of profile parameters;
receiving a first candidate entity profile including a plurality of parameter values characterizing a candidate entity, with the plurality of parameters of the first candidate entity profiles respectively corresponding to the plurality of profile parameters;
determining a first gap between the following: (i) a first parameter value and/or range of the plurality of parameter values and/or ranges of the target profile, and (ii) a first parameter value and/or range of the plurality of parameter value of the first candidate entity profile; and
performing gap analysis to identify a first action that may be undertaken by the first candidate entity to decrease or eliminate the first gap;
wherein the performance of gap analysis uses the following inputs: a set of personas P from a generation module and a test instance for the gap analysis, with each persona P respectively corresponding to an archetypical user created by synthesizing descriptions of user segments;
wherein the user segments include a first user segment corresponding to individuals who perform large deals in the commercial area of telco;
wherein the performance of gap analysis generates the following output: a ranked list of recommendations; and
wherein the operation of performance of the gap analysis includes at least the following sub-operations:
processing a set of input personas P to determine main descriptors,
computing for the input test instance, a similarity score s_p for each of the personas P,
ranking, in ascending order of s_p, all the success personas in P, and
determining minimal change in features of input test instance to top ranked personas identified in the previous operation.

20. The CIM of claim 19 further comprising:
communicating the first action to the first candidate entity by an electronic communication made over a communication network.

21. The CIM of claim 19 wherein the first task is the provision of computing services.

22. The CIM of claim 21 wherein the first task is the provision of cloud computing services.
